(19) United States
(12) Patent Application Publication
(10) Pub. No.: US 2025/0116321 A1
(43) Pub. Date: Apr. 10, 2025

(54) METHOD OF REATTACHING A CAMSHAFT GEAR TO A CAMSHAFT WITHOUT REMOVING THE CAMSHAFT

(71) Applicant: Robert J. Halisky, Cottonwood, AZ (US)

(72) Inventor: Robert J. Halisky, Cottonwood, AZ (US)

(21) Appl. No.: 18/376,946

(22) Filed: Oct. 5, 2023

(51) Int. Cl. F16H 53/02; B23G 1/16

(52) U.S. Cl. CPC F16H 53/025; B23G 1/16; B23G 2210/04

(57) ABSTRACT

A method of resecuring a camshaft gear to a camshaft after the camshaft gear has been removed to service an engine wherein the camshaft remains in the engine comprising: tapping a channel in an end of the camshaft where the camshaft gear is removed; securing a forcing screw within the channel; placing the camshaft gear on the camshaft; and rotating a forcing nut on the forcing screw until the camshaft gear is seated and secured on the camshaft.

### TECHNICAL FIELD

The present application relates generally to combustion engines, and more specifically, to a method of reattaching a camshaft gear to a camshaft after the camshaft gear has been removed to service the engine, specifically a Cummins Inline 6 engine.

### BACKGROUND

A camshaft is a device in an internal combustion engine that may control the input of fuel and the expulsion of exhaust fumes. The camshaft may consist of several radial cams, each displacing intake or exhaust valves. This camshaft may be connected to the crankshaft via belt, chain, or gears. In general, the camshaft may be fitted in the internal combustion engine in such a manner that the cams may be fitted on and bear against cam followers, for example bucket tappets, drag levers or rocker arms. If the camshaft is caused to rotate, the cams may roll off along the cam followers which in turn actuate the gas exchange valves.

When performing certain services on an engine, the camshaft gear attached to the camshaft may need to be removed. After the engine service has been performed, reattaching the camshaft gear to the camshaft may be an expensive, time consuming and frustrating process. For many engines, reattaching the camshaft gear to the camshaft may require the camshaft to be removed from the engine of the vehicle.

Because of its uniqueness and efficiency, the Cummins inline 6 engine has become popular with light and medium duty truck owners. However, like many engines, certain services on the Cummins inline 6 engine may require the camshaft gear to be removed from the camshaft. After the engine service has been performed, reattaching the camshaft gear to the camshaft, the Cummins inline 6 engine generally requires the camshaft to be removed from the engine.

Therefore, it would be desirable to provide a system and method that overcomes the above. The system and method would provide a means to reattach the camshaft gear to the camshaft without having to remove the camshaft from the engine of the vehicle. The system and method would provide a means to reattach the camshaft gear to the camshaft without having to remove the camshaft from a Cummins inline 6 engine.

### SUMMARY

In accordance with one embodiment, a method of resecuring a camshaft gear to a camshaft after the camshaft gear has been removed to service an engine wherein the camshaft remains in the engine is disclosed. The method comprises: tapping a channel in an end of the camshaft where the camshaft gear is removed; securing a forcing screw within the channel; placing the camshaft gear on the camshaft; and rotating a forcing nut on the forcing screw until the camshaft gear is seated and secured on the camshaft.

In accordance with one embodiment, a method of resecuring a camshaft gear to a camshaft after the camshaft gear has been removed to service an engine wherein the camshaft remains in the engine is disclosed. The method comprises: forming a channel in an end of the camshaft where the camshaft gear is removed; securing a forcing screw within the channel; placing the camshaft gear on the camshaft while aligning timing markings; and rotating a forcing nut on the forcing screw until the camshaft gear is seated and secured on the camshaft.

In accordance with one embodiment, a method of resecuring a camshaft gear to a camshaft after the camshaft gear has been removed to service an engine wherein the camshaft remains in the engine is disclosed. The method comprises: center punching a center area on an end of the camshaft where the camshaft gear is removed; forming a channel the center area marked in the end of the camshaft where the camshaft gear is removed; forming threading within the channel; securing a forcing screw within the channel; placing the camshaft gear on the camshaft while aligning timing markings; placing a thrust washer, bearing and then a forcing nut on the forcing screw; and rotating a forcing nut on the forcing screw until the camshaft gear is seated and secured on the camshaft.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 is a perspective view of an exemplary embodiment of an engine in accordance with one embodiment of the present invention;

FIG. 2 is a perspective view of an exemplary embodiment of internal components of the engine of FIG. 1 in accordance with one embodiment of the present invention; and

FIG. 3 is an exploded view of an exemplary embodiment of a portion of the internal components of the engine of FIG. 2 in accordance with one embodiment of the present invention.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary system and method disclose a means for reattaching a camshaft gear to a camshaft after serving an engine. The system and method allow the camshaft gear to be reattached to the camshaft without having the user remove the camshaft from the engine of the vehicle. More specifically, the system and method allow the camshaft gear to be reattached to the camshaft of a Cummins inline 6 engine without having the user remove the camshaft from the Cummins inline 6 engine.

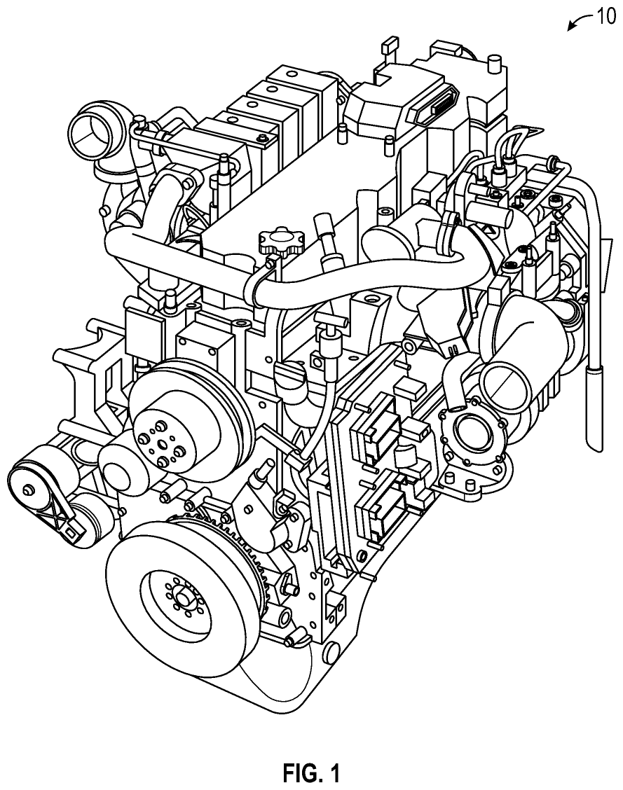

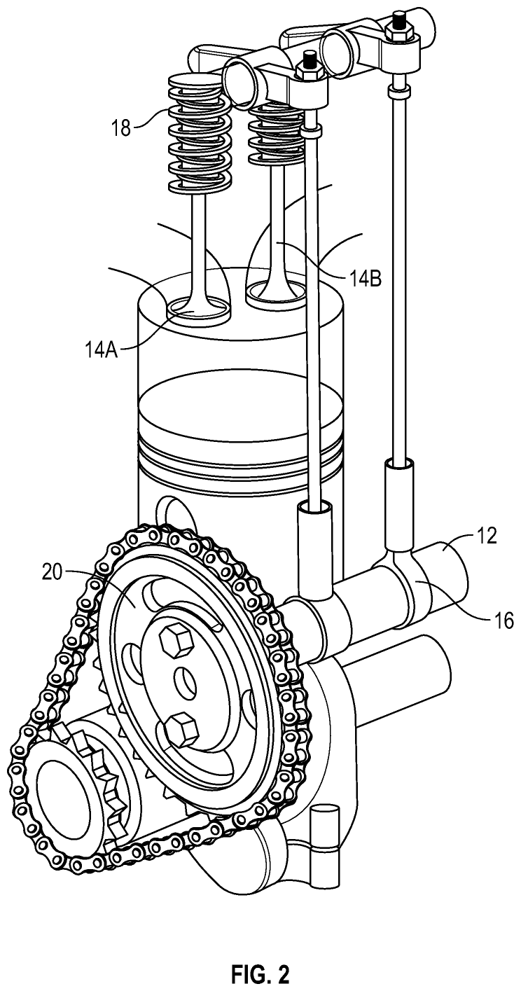

Referring to FIGS. 1 and 2, an engine 10 may be disclosed. In the present embodiment, the engine 10 may be Cummins inline 6 engine. The engine 10 may have a camshaft 12. The camshaft 12 which may be used to operate the opening and closing of intake 14A and exhaust 14B valves. The camshaft 12 may use cams 16 that may push against the intake and exhaust valves 14A and 14B to open them as the camshaft 12 rotates. Springs 18 on the intake and exhaust valves 14A and 14B may return intake and exhaust valves 14A and 14B to the closed position. A camshaft gear 20 may be attached to an end of the camshaft 12. The camshaft gear 20 may allow the rotation of the camshaft 12 to correspond or be in time with, the rotation of the crank shaft and thereby allows the intake and exhaust valves 14A and 14B opening and closing, and injection of fuel to be timed to occur at precise intervals in the piston's travel.

When performing certain services on the engine 10, the camshaft gear 20 may need to be removed. However, reinstalling the camshaft gear 20 on the camshaft 12 generally requires the removal of the camshaft 12 from the engine 10 of the vehicle. Many engine manuals recommend the removal of the camshaft 12 from the engine 10 of the vehicle, reattaching the camshaft gear 20 on the camshaft 12, and then reinstalling the camshaft 12 with the camshaft gear 20 in the engine 10. In general, there may be no other alternative due to the difficulty to properly reattach the camshaft gear 20 on the camshaft 12.

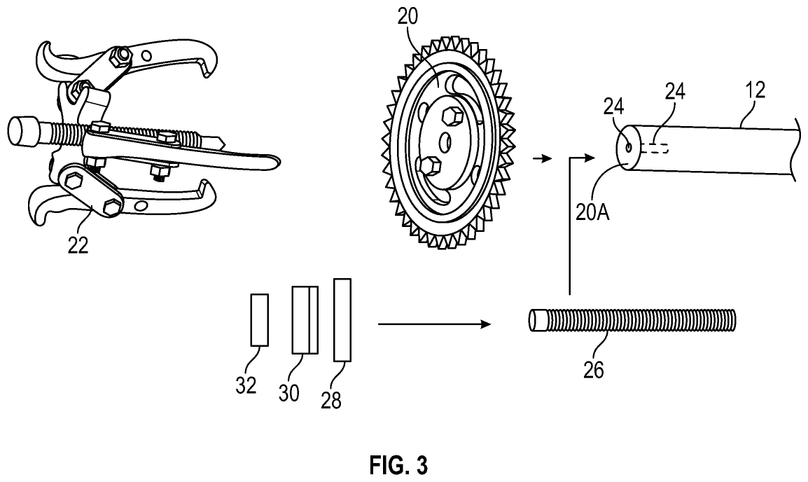

Referring now to FIGS. 1-3, a method for reattaching the camshaft gear 20 on the camshaft 12 without having to remove the camshaft 12 from the engine 10 of the vehicle may be disclosed. In accordance with one embodiment, the method for reattaching the camshaft gear 20 on the camshaft 12 may be used on a vehicle having a Cummins inline 6 engine.

In order to remove the camshaft gear 20 from the camshaft 12 to perform certain services on the engine 10, a gear puller 22 may be used. The legs of the gear puller 22 may be inserted into the camshaft gear 20 and tightened. The gear puller 22 may then be rotated forcing a screw(s) securing the camshaft gear 20 to the camshaft 12 to loosen. With the screw loosened and removed, the gear puller 22 may be used to pull the camshaft gear 20 off from the camshaft 12. With the camshaft gear 20 removed, one can perform the maintenance required on the engine 10.

To reattach the camshaft gear 20 from the camshaft 12, the mechanic may first place a towel around the crankshaft gear area where the camshaft gear 20 may be reinstalled. The towel may be used to prevent debris from entering into the engine 10. In accordance with one embodiment, the towel may be positioned above the crankshaft gear and over an oil pan lip to prevent debris, more specifically metal shavings as will be described below, from entering the engine. A channel 24 may then be drilled into the camshaft gear 20. The channel 24 may be positioned on an end 20A of the camshaft 12 where the camshaft gear 20 was removed. The channel 24 may be positioned in a center area of the end 20A and run parallel to a length of the camshaft gear 20. In accordance with one embodiment, the channel 24 may have a diameter of 11/32″ and run a depth of approximately 1½″ down a length of the camshaft 20. A 11/32″ stubby drill bit may be used in accordance with one embodiment. Prior to drilling the channel 24, a center punch may be used to mark an area in the center of the end 20A. The center punch may be used to mark and prevent the drill from sliding when forming the channel 24.

The channel 24 may then be tapped. Tapping is a process of creating threads inside of the channel 24. In accordance with one embodiment, a ⅝″ tap hole may be formed using a No. 24 tap. After being tapped, the channel 24 may be cleaned. Compressed air may be injected into the channel 24 to clean out any debris that may be within the channel 24. During the cleaning process, the person cleaning the channel 24 may want to wear protective eyewear to prevent any debris being cleanout of the channel 24 from going into the cleaner's eyes.

A forcing screw 26 may then be placed within the opening of the channel 24. The mechanic may thread the forcing screw into the channel 24 until the forcing screw 26 bottoms out. The cam shaft gear 20 may then be placed on the camshaft 12. When placing the cam shaft gear 20 on the camshaft 12, the mechanic may need to ensure that the timing marks are aligned. A thrust washer 28, bearing 30 and then a forcing nut 32 may be placed on the forcing screw 26. The forcing nut 32 may be rotated until the cam shaft gear 20 is fully seated and secured on the camshaft 12.

The foregoing description is illustrative of particular embodiments of the application but is not meant to be a limitation upon the practice thereof. The following claims, including all equivalents thereof, are intended to define the scope of the application.

What is claimed is:

1. A method of resecuring a camshaft gear to a camshaft after the camshaft gear has been removed to service an engine, wherein the camshaft remains in the engine comprising:
tapping a channel in an end of the camshaft where the camshaft gear is removed;
securing a forcing screw within the channel;
placing the camshaft gear on the camshaft; and
rotating a forcing nut on the forcing screw until the camshaft gear is seated and secured on the camshaft.

2. The method of claim 1, comprising positioning a covering over exposed elements of the engine before tapping the channel.

3. The method of claim 1, comprising aligning timing marking when placing the camshaft gear on the camshaft.

4. The method of claim 1, comprises center punching a center area on the end of the camshaft where the camshaft gear is removed before tapping the channel.

4. The method of claim 1, wherein tapping the channel comprises forming a threaded channel in the end of the camshaft where the camshaft gear is removed.

5. The method of claim 4, wherein the threaded channel has a diameter of 11/32″ and a depth of 1½″ down a length of the camshaft.

6. The method of claim 1, wherein tapping the channel comprises:
drilling the channel with a 11/32″ stubby drill bit;
tapping the channel with a ⅝″ tap.

7. The method of claim 1, comprising placing a thrust washer, bearing and then the forcing nut on the forcing screw after placing the camshaft gear on the camshaft.

8. A method of resecuring a camshaft gear to a camshaft after the camshaft gear has been removed to service an engine, wherein the camshaft remains in the engine comprising:
forming a channel in an end of the camshaft where the camshaft gear is removed;
securing a forcing screw within the channel;
placing the camshaft gear on the camshaft while aligning timing markings; and
rotating a forcing nut on the forcing screw until the camshaft gear is seated and secured on the camshaft.

9. The method of claim 8, comprising forming threading within the channel.

10. The method of claim 8, comprises center punching a center area on the end of the camshaft where the camshaft gear is removed before forming the channel.

11. The method of claim 8, wherein forming the channel comprises forming a threaded channel having a diameter of 11/32″ and a depth of 1½″ down a length of the camshaft.

12. The method of claim 8, wherein forming the channel comprises drilling the channel with a 11/32″ stubby drill bit.

13. The method of claim 9, comprising forming threading within the channel comprises tapping the channel with a ⅝″ tap.

14. The method of claim 8, comprising placing a thrust washer, bearing and then the forcing nut on the forcing screw after placing the camshaft gear on the camshaft.

15. The method of claim 8, comprising positioning a covering over exposed elements of the engine before tapping the channel.

16. A method of resecuring a camshaft gear to a camshaft after the camshaft gear has been removed to service an engine, wherein the camshaft remains in the engine comprising:
center punching a center area on an end of the camshaft where the camshaft gear is removed;
forming a channel in the center area marked in the end of the camshaft where the camshaft gear is removed;
forming threading within the channel;
securing a forcing screw within the channel;
placing the camshaft gear on the camshaft while aligning timing markings;
placing a thrust washer, bearing and then a forcing nut on the forcing screw; and
rotating a forcing nut on the forcing screw until the camshaft gear is seated and secured on the camshaft.

17. The method of claim 16, wherein the channel having threading has a diameter of 11/32″ and a depth of 1½″ down a length of the camshaft.

18. The method of claim 16, wherein forming the channel comprises drilling the channel with a 11/32″ stubby drill bit.

19. The method of claim 16, wherein forming threading within the channel comprises tapping the channel with a ⅝″ tap.

20. The method of claim 16, comprising positioning a covering over exposed elements of the engine before tapping the channel.
